(19) United States
(12) Patent Application Publication
(10) Pub. No.: US 2007/0029969 A1
(43) Pub. Date: Feb. 8, 2007

(54) ENERGY SAVING SYSTEM AND METHOD

(76) Inventors: Han-Che Wang, Shenzhen (CN); Shin-Hong Chung, Shenzhen (CN); Kuan-Hong Hsieh, Shenzhen (CN); Wen-Chuan Lian, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,978

(22) Filed: Jun. 1, 2006

(30) Foreign Application Priority Data
Jul. 22, 2005 (CN) 200510036155.1

(51) Int. Cl. H02J 7/00

(52) U.S. Cl. 320/128

(57) ABSTRACT

An energy saving system used in an electronic device is provided. The energy saving system includes a battery for supplying the electronic device with energy; a energy detector for measuring a energy level of the battery, and transmitting a battery energy saving control signal when the measured energy level is equal to or less than a predetermined energy level; and a control unit for controlling the electronic device to enter a energy saving mode according to the battery energy saving control signal. An energy saving method for an electronic device is also provided.

### CROSS-REFERENCES TO RELATED APPLICATION

This application relates to a contemporaneously filed application filing number entitled “ENERGY SAVING SYSTEM” having at least one common inventor and the same assignee with the instant application.

### TECHNICAL FIELD

The present invention relates generally to energy saving systems and methods, and particularly to a system and method for saving energy of a battery.

### GENERAL BACKGROUND

In recent years, as electronic devices decrease in size and thickness, portable electronic device, such as, notebook computers, mobile telephones, are widely used in today's business scenes. In the circumstance that an Alternating Current (AC) power is not available, electronic devices typically including such notebook computers will be electrically driven by rechargeable batteries loaded therein. It will be desirable for most users that the electronic devices run longer before the battery runs down.

An approach in prolonging the battery drive time period is to precisely control the energy being consumed by a display unit of the electronic device. When a user does not use the electronic device for a time period, the display unit will enter a sleep mode.

However, in the described above approach the amount of energy saved is limited, which can not efficiently prolong the battery drive time more.

Accordingly, what is needed is a energy saving system and method which can overcome the above-described problem and meet user's needs.

### SUMMARY

An energy saving system used in an electronic device is provided. The energy saving system includes a battery, an energy detector, and a control unit. The battery is for supplying the electronic device with energy. The energy detector is for measuring an energy level of the battery of the electronic device, and transmitting a battery energy saving control signal when the measured energy level is equal to or less than a predetermined energy level. The control unit is for controlling the electronic device to enter an energy saving mode according to the battery energy saving control signal.

An energy saving method used in an electronic device is also disclosed. The energy saving method includes the steps of: (a) measuring a energy level of a battery of the electronic device; (b) transmitting a battery energy saving control signal when the measured energy level is equal to or less than a predetermined energy level; (c) controlling the electronic device to enter a energy saving mode according to the battery energy saving control signal.

Another energy saving system used in an electronic device is provided. The energy saving system includes an energy detector, a control unit and, a backlight driver. The energy detector measures a energy level of a battery of the electronic device, and transmits a battery energy saving control signal when the measured energy level is equal to or less than a predetermined energy level. The control unit transmits a control instruction corresponding to the battery energy saving control signal. The backlight driver decreases an initial voltage supplied to a Light-Emitting Diode (LED) according to the control instruction.

Another energy saving method used in an electronic device is also provide. The energy saving method comprising the steps of: (a) measuring a energy level of a battery of the electronic device; (b) transmitting a battery energy saving control signal when the measured energy level is equal to or less than a predetermined energy level; (c) transmitting a control instruction for saving the energy of the battery corresponding to the battery energy saving control signal; and (d) decreasing voltage supplied to a Light-Emitting Diode (LED).

Other advantages and novel features will be drawn from the following detailed description of the embodiments with reference to the attached drawings, in which:

### BRIEF DESCRIPTION OF DRAWINGS

FIG. 1 is a block diagram of a hardware infrastructure of an energy saving system according to a preferred embodiment of the present invention;

FIG. 2 is a flowchart of a preferred method of implementing the energy saving system of FIG. 1;

FIG. 3 is a flowchart of implementing one step of the method of FIG. 2, namely controlling a backlight driver to decrease a voltage supplied to a Low-Emitting Diode (LED); and

FIG. 4 is a flowchart of implementing another step of the method of FIG. 2, naming controlling a mobile telephone to enter a sleep mode state within a shortened time period.

### DETAILED DESCRIPTION OF THE PREFERRED EMBODIMENT

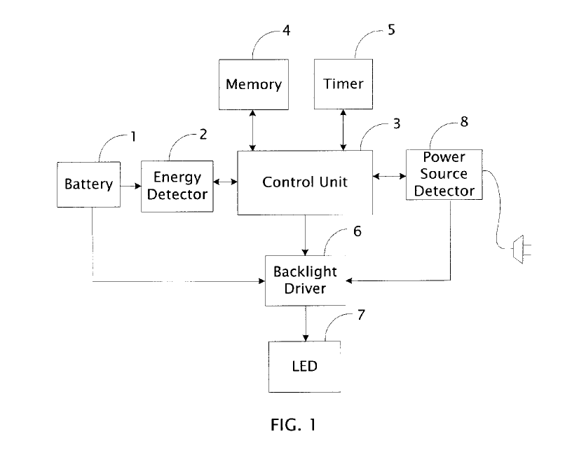

FIG. 1 is a block diagram of a hardware infrastructure of an energy saving system (hereafter, “the system”) according to a preferred embodiment of the present invention. The system can be used in any types of electronic device including, but not limited to, a mobile telephone, a notebook computer, a media player, a personal digital assistant (PDA), an E-book, and so forth. For simplicity, in the preferred embodiment, the following description will be provided with respect to a mobile telephone as the electronic device.

In the preferred embodiment, the system includes a battery 1, a energy detector 2, a control unit 3, a memory 4, and a timer 5. The memory 4 stores information used or generated by the mobile telephone, such as a plurality of predetermined parameters. The plurality of predetermined parameters include a predetermined energy level of the battery 1, a predetermined first time period, and a predetermined second time period. Each time period represents a time interval between a state of not receiving any operation on the mobile telephone and a sleep mode state of the mobile telephone. Therefore, when an elapsed time of not receiving any operations on the mobile telephone reaches the predetermined first time period, the mobile telephone starts to enter the sleep mode state. In this preferred embodiment, the predetermined first time period is designated as a default time period for the mobile telephone. In addition, the predetermined first time period is a time length longer than the predetermined second time period. The battery 1 supplies energy for the mobile telephone. The energy detector 2 measures energy level of the battery 1, and transmits a battery energy saving control signal to the control unit 3 when the measured energy level equals a predetermined energy level. The timer 5 tracks an elapsed time when no operation on the mobile telephone is received.

The system further includes a backlight driver 6 and a Light-Emitting Diode (LED) 7. The LED 7 is a light source used for an LCD (Liquid Crystal Display) (not shown). The backlight driver 7 adjusts a voltage supplied to the LED 7 thereby adjusting a brightness of the LED 7. The control unit 3 generates a control instruction according to the battery energy saving control signal, and transmits the control instruction to the backlight driver 6. The backlight driver 6 decreases an initial voltage supplied to the LED 7 according to the control instruction, thereby reducing the brightness of the LED 7. Furthermore, the control unit 3 changes the default time period for the mobile telephone from the predetermined first time period to the predetermined second time period according to the battery energy saving control signal, thereby shortening the time period before the mobile telephone enters the sleep mode state. Accordingly, when the elapsed time of not receiving any operation on the mobile telephone reaches the predetermined second time period, the control unit 3 controls the mobile telephone to enter the sleep mode state. In the sleep mode state, the display of the mobile telephone is turned off.

As described above, the mobile telephone can decrease the voltage supplied to the LED and simultaneously shorten the predetermined time period needed to enter the sleep mode state, thereby reducing energy consumption of the battery 1. However, the mobile telephone may adopt only one of the energy saving modes in other cases.

The system further includes a power source detector 8. The power source detector 8 detects whether a mains power source (not shown) is connected to (or another battery 1 is installed on (not shown)) the mobile telephone. If the mains power source is connected to the mobile telephone, the power source detector 8 generates a energy restoring control signal to restore an initial voltage. The control unit 3 controls the backlight driver 6 to restore the initial voltage supplied to the LED 7, and restores the predetermined first time period for the electronic device according to the energy restoring control signal.

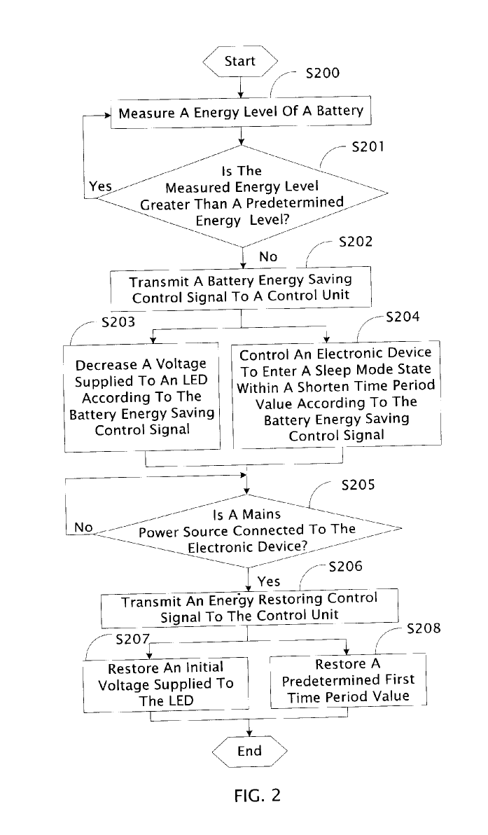

FIG. 2 is a flowchart of a preferred method of implementing the energy saving system of FIG. 1. In the flowchart, the method simultaneously adopts the two energy saving modes (one is that decrease the voltage supplied to the LED, another is that shorten the predetermined time period needed to enter the sleep mode state) as example. In step S200, the energy detector 2 measures the energy level of the battery 1. In step S201, the energy detector 2 determines whether the measured energy level is greater than the predetermined energy level. If the measured energy level is greater than the predetermined energy level, the procedure returns to step S200 described above. If the measured energy level is equal to or less than the predetermined energy level, in step S202, the energy detector 2 transmits the battery energy saving control signal 1 to the control unit 3. In step S203, the control unit 3 controls the backlight driver 6 to decrease voltage supplied to the LED 7 corresponding to the battery energy saving control signal. In step S204, the control unit 3 further controls the mobile telephone to enter a sleep mode state within a shortened time period according to the battery energy saving control signal, i.e., changes the current time period of the mobile telephone from the predetermined first time period to the predetermined second time period.

In step S205, the power source detector 8 detects whether a mains power source is connected to (or another battery 1 is installed on (not shown)) the mobile telephone in real time. If no mains power source is connected to the mobile telephone, the procedure repeats step S205 described above. If the mains power source is connected to the mobile telephone, in step S206, the power source detector 8 transmits the energy restoring control signal to the control unit 3. In step S207, the control unit 3 controls the backlight driver 6 to restore the initial voltage supplied to the LED 7 according to the energy restoring control signal. Furthermore, in step S208, the control unit 3 restores the predetermined first time period according to the energy restoring control signal.

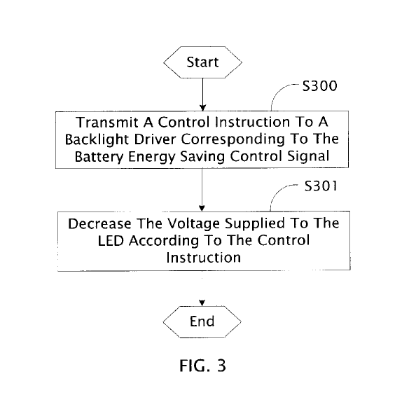

FIG. 3 is a flowchart of implementing step S203 of the method of FIG. 2, namely controlling the backlight driver 6 to decrease the voltage supplied to the LED 7. In step S300, the control unit 3 transmits the control instruction to the backlight driver 6 corresponding to the battery energy saving control signal 1. In step S301, the backlight driver 6 decreases the voltage supplied to the LED 7 according to the control instruction.

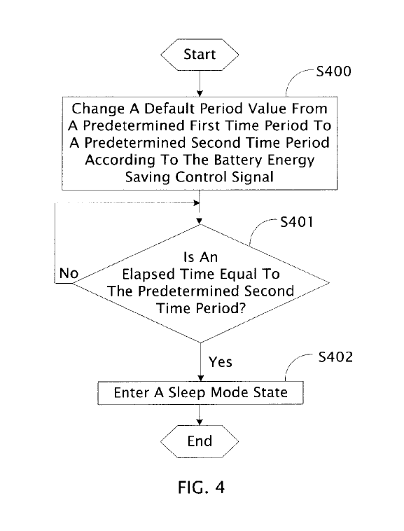

FIG. 4 is a flowchart of implementing step S204 of the method of FIG. 2, namely controlling the mobile telephone to enter a sleep mode state within a shortened time period. In step S400, the control unit 3 changes the default time period for the mobile telephone from the predetermined first time period to the predetermined second time period according to the battery energy saving control signal. In step S401, the control unit 3 determines whether the elapsed time of the timer 5 is equal to the predetermined second time period. If the elapsed time is not equal to the predetermined second period, the procedure repeats step S401. If the elapsed time reaches the predetermined second period, in step S402, the control unit 3 controls the mobile telephone to enter the sleep mode state.

Although the present invention has been specifically described on the basis of the preferred embodiment including the preferred method, the invention is not to construed as being limited thereto. Various changes or modifications may be made to the embodiment including the method without departing from the scope and spirit of the invention.

What is claimed is:

1. An energy saving system used in an electronic device, the system comprising:
a energy detector for measuring a energy level of a battery of the electronic device, and transmitting a battery energy saving control signal when the measured energy level is equal to or less than a predetermined energy level; and
a control unit for controlling the electronic device to enter a energy saving mode according to the battery energy saving control signal.

2. The energy saving system as described in claim 1, wherein the control unit controls the electronic device to decrease an initial voltage supplied to a Light-Emitting Diode (LED), changes a predetermined first time period which is a time interval between a state of not receiving any operation on the electronic device and a sleep mode state of the electronic device into a predetermined second time period which is shorter than the predetermined first time period according to a control instruction transmitted by the control unit corresponding to the battery energy saving control signal, and controls the electronic device to enter a sleep mode state when the elapsed time reaches the predetermined second time period.

3. The energy saving system as described in claim 2, further comprising a power source detector for detecting whether a mains power source is connected to the electronic device, and transmitting a energy restoring control signal for restoring an initial voltage supplied to the electronic device if the mains power source is connected to the electronic device.

4. The energy saving system as described in claim 3, wherein the control unit controls the electronic device to restore the initial voltage supplied to the LED and the predetermined first period for the electronic device according to the energy restoring control signal.

5. An energy saving system used in an electronic device, the system comprising:
a energy detector for measuring a energy level of a battery of the electronic device, and transmitting a battery energy saving control signal when the measured energy level is equal to or less a predetermined energy level;
a control unit for transmitting a control instruction corresponding to the battery energy saving control signal; and
a backlight driver for decreasing an initial voltage supplied to a Light-Emitting Diode (LED) according to the control instruction.

6. The energy saving system as described in claim 5, further comprising a power source detector for detecting whether a mains power source is connected to the electronic device, and transmitting a energy restoring control signal for restoring the initial voltage supplied to the LED if the mains power source is connected to the electronic device.

7. The energy saving system as described in claim 6, wherein the control unit controls the backlight driver to restore the initial voltage supplied to the LED.

8. An energy saving method used in an electronic device, the method comprising the steps of:
measuring a energy level of a battery of the electronic device;
transmitting a battery energy saving control signal when the measured energy level is equal to or less than a predetermined energy level; and
controlling the electronic device to enter a energy saving mode corresponding to the battery energy saving control signal.

9. The method as described in claim 8, further comprising the steps of:
decreasing the voltage supplied to a Light-Emitting Diode (LED) according to a control instruction transmitted by the control unit corresponding to the energy saving control signal;
changing a predetermined first time period which is the time interval between a state of not receiving any operation on the electronic device and a sleep mode state of the electronic device into a predetermined second time period that is shorter than the predetermined first period according to the energy saving control signal; and
controlling the electronic device to enter the sleep mode state when an elapsed time value reaches the predetermined second time period.

10. The method as described in claim 9, further comprising the steps of:
determining whether a mains power source is connected to the electronic device;
transmitting a energy restoring control signal for restoring an initial voltage supplied to the electronic device if the mains power source is connected to the electronic device; and
controlling the electronic device to restore the initial voltage supplied to the LED and the predetermined first time period as the default time period for the electronic device according to the energy restoring control signal.

11. An energy saving method used in an electronic device, the method comprising the steps of:
measuring a energy level of a battery of the electronic device;
transmitting a battery energy saving control signal when the measured energy level is equal to or less than a predetermined energy level;
transmitting a control instruction for saving the energy of the battery corresponding to the battery energy saving control signal; and
decreasing voltage supplied to a Light-Emitting Diode (LED).

12. The energy saving method as described in claim 11, further comprising the steps of:
detecting whether a mains power source is connected to the electronic device;
transmitting a energy restoring control signal for restoring the initial voltage supplied to the LED if the mains energy source is connected to the electronic device; and
controlling the electronic device to restore an initial voltage according to the energy restoring control signal.
